(19) United States
(12) Patent Application Publication
(10) Pub. No.: US 2011/0310595 A1
(43) Pub. Date: Dec. 22, 2011

(54) Lighted Flooring

(76) Inventor: Gary Hardesty, Oakland, MD (US)

(21) Appl. No.: 12/986,936

(22) Filed: Jan. 7, 2011

Related U.S. Application Data
(60) Provisional application No. 61/355,235, filed on Jun. 16, 2010.

(51) Int. Cl. F21S 8/00

(52) U.S. Cl. 362/153

(57) ABSTRACT

A portable flooring having integral illumination devices. The flooring comprises a panel having channels extending along a front portion of the panel. Light strips in the channels are supported by the back portion of the panel. The light strips have a covering that extends along the length of the light strips. A top surface of the covering and a top surface of the panel are on the same plane. The flooring can support large weighted objects.

### RELATED APPLICATIONS

The present application is a continuation of prior U.S. Patent Application 61/355235 filed on Jun. 16, 2010, the entirety of which is incorporated herein by reference.

### FIELD OF THE INVENTION

The present invention relates in general to flooring and in particular to a mat having illumination devices that provide lighting in a dim or dark area.

### BACKGROUND OF THE INVENTION

Flooring is available in various shapes, size, and colors. Smaller dimensioned flooring such as mats are placed over surfaces for providing protection to a larger flooring underneath the mat. Mats may also be used to provide comfort and cushion to one having to stand or lay on the mats for long time periods. Floor mats also provide safe surfaces on which to walk, preventing slips and falls that cause injury and liability damages. A well-used mat can trap and hold dirt and allergens, preventing their spread.

### SUMMARY OF THE INVENTION

This invention introduces portable flooring in the form of a mat having integral illumination devices.

An aspect of an embodiment of the invention provides the mat being positioned on a surface whereby the illumination devices project onto a surface above the mat.

A further aspect of an embodiment of the invention provides the mat and illumination devices being durable to support and withstand large weight objects.

A further aspect of an embodiment of the invention provides the mat having channels that house the illumination devices.

Additional aspects, objectives, features and advantages of the present invention will become apparent from the following description of the preferred embodiments with reference to the attached drawings.

### BRIEF DESCRIPTION OF THE DRAWINGS

FIG. 1 is a perspective view of the lighted flooring.

FIG. 2 is a perspective view of the lighted flooring without the light strips.

FIG. 3 is a back view of the lighted flooring illustrating a light strip connection and an outer edge.

FIG. 4 is a back view of the lighted flooring illustrating a cord extending out of the panel and an outer edge.

FIG. 5 is a front view of the lighted flooring illustrating a cord extending out of the panel and an outer edge.

FIG. 6 is an end view of the lighted flooring.

### DETAILED DESCRIPTION OF THE INVENTION

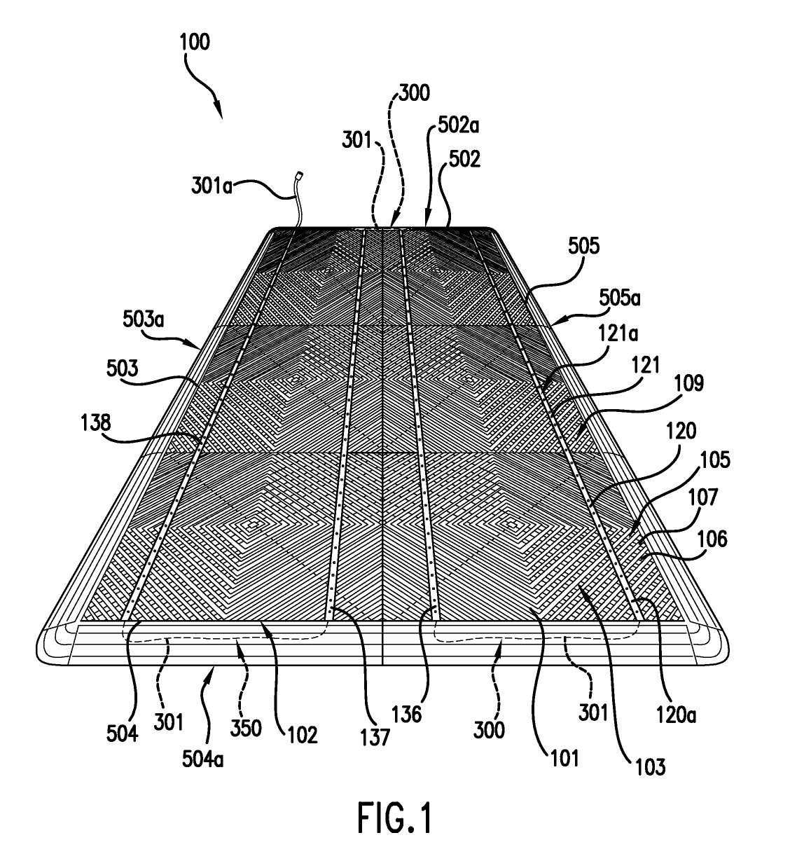

FIG. 1 is a perspective view of the lighted flooring 100. The flooring 100 features tiles 101 connected together to form a panel 102. The panel can have a length of 4 ft and a width of 3 ft to create a mat. The tiles 101 are in a square shape having connection mechanisms that allow the tiles 101 to lock into each other. Additional shapes of tiles may be used to form a panel with a different shape. The panel size or dimensions are based on the number of tiles connected and the panel can be made larger or smaller.

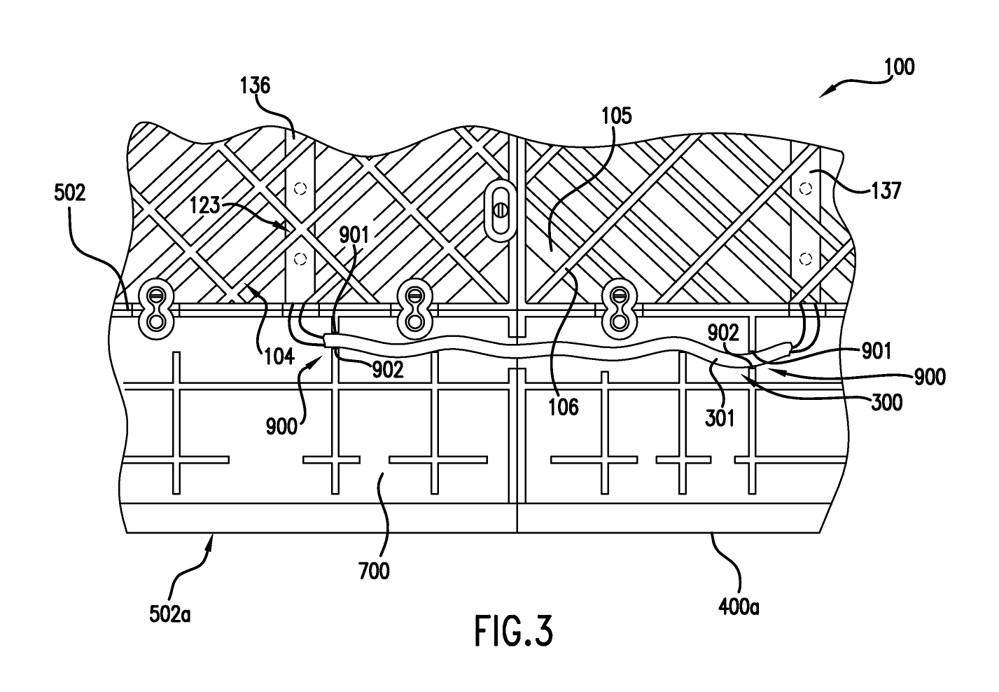

The tiles have a front portion 103 and a back portion 104, shown in FIG. 3. In a preferred embodiment of the invention, the tiles 101 are made of front ribs 105 on the front portion 103 of the tiles 101 and back ribs 106 on the back portion 104 of the tiles 101. The front ribs 105 rest on the back ribs 106 in a checkerboard fashion such that the front and back ribs are positioned to form apertures between them 107. The ribs 105, 106 can form an alternate pattern or design. However, spaces 107 are formed between each front rib 105 which allow unwanted fluid such as oil or gas or small objects to pass through the spaces 107.

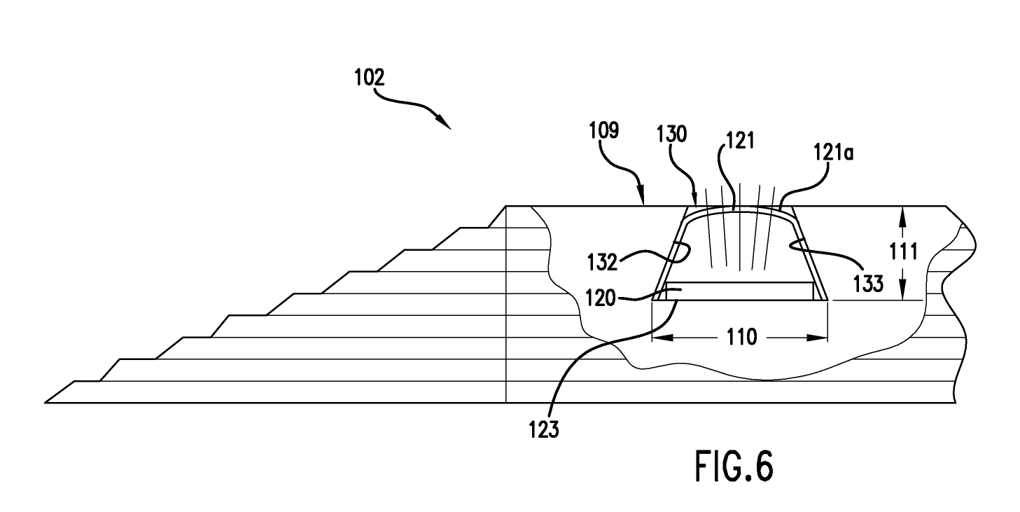

Alternatively, the tiles may be designed such that they do not contain spaces 107. The tiles are made from a polypropylene copolymer having a light weight and they are able to support large weight objects. The material may be a polymer able to support objects. Each tile is about 15.75 square inches but may be made to be smaller or larger based on the space for the flooring 100. Additional tiles may be connected to form a panel to cover the floor of a large room or the panel may be designed to fit underneath smaller objects such as motorcycles or bikes. When the tiles 101 are connected to form the panel 102, the panel 102 can support the weight of large objects such as cars or trucks. Each tile comprises a tile 108. The tile channels 108 have a width 110 and a depth 111 as shown in FIG. 6.

The channels 108 are recessed into the panel 102. FIG. 6 is an end view of the lighted flooring. The depth 111 is the area from the top surface 109 of the panel 102 to the bottom of the light strip 120. The width 110 is about ½ in wide and the depth 111 is about ¼ in below the top surface 109 of the panel 102. The width of the channel may be larger or smaller based on the size of the light strips 120. Also, the depth may be larger based on the thickness of the light strips 120. A top surface 123 of the back ribs 104 contacts the bottom of the light strip 120 and provides additional support for the light strip 120. The tile channels 108 can be aligned on each panel as shown in FIG. 1 or the channels may be cut to form symbols, numbers or designs. As shown in FIG. 1, the channels are symmetrical on a first and second half of the panel. In FIG. 1, the tiles channels 108 are aligned and form a first channel 130. The channels are formed by cutting the front ribs at a location on the tiles.

In an alternative embodiment, a panel can be sized to a desired size for a mat or flooring. The panel will be in the form of a sheet of material. A top surface 109 of the panel 102 can be cut to form channels 108 on the panel 102 as shown in FIG. 6. The channels 108 will be cut a width 110 to support a light strip 120 and will be cut a depth 111 from a top surface of the panel to a top surface of the bottom of the panel, such that the top surface of the bottom of the panel supports the bottom of the light strip where it comes into contact with the outer covering of the strip. The channels 108 are cut and sized to hold the light strips in position. The covering of the light strip is flush with the top surface of the panel.

Illumination devices, a LED light strip 120 having a waterproof sheath covering 121 is positioned in the first channel 130. The LED light strip is long lasting, saves energy, is durable and ultra-bright. The light strip 120 is a flexible strip in the form of a ribbon or rope. The channels 108 are cut such that side cuts 132, 133 are angled and the top surface of the back rib is flat. It is preferred the cuts 132, 133 be angled for added protection, however, a square cut can be made in the event the flooring will not be used in a high travelled area. The angled cuts 132, 133 are a dove-tail shaped. The angled cut sides 132, 133 are angled to act as a bridge to protect the light strips. The LED strips 120 are recessed in the channels in a manner that prevents them from being crushed or damaged when the panel is supporting a large object. The cuts 132, 133 allow the strips 120 to be positioned such that no additional covering is necessary, once the strips are positioned in the channels 108.

For example, the panel 102 can be positioned in a location on the floor of an auto mechanics shop. When a vehicle is driven over the mat the covering 121 and the side cuts 132, 133 prevent the LEDs from being damaged. When a car is lifted, the mechanic can keep his hands free and use the light emitted by the LEDs 120a to see underneath the car. The LED strips 120 act as a spotlight. When the LED strips 120 are in the channel 130, the top 121a of the covering 121 is flush with the top surface 109 of the front ribs 105. The top surface of the covering and the top surface of the tiles are on the same plane. No additional covering is required above the covering 121 of the light strips 120. The channels are sized to receive the light strips 120 and there are no gaps such that the light strip plugs the channels 130.

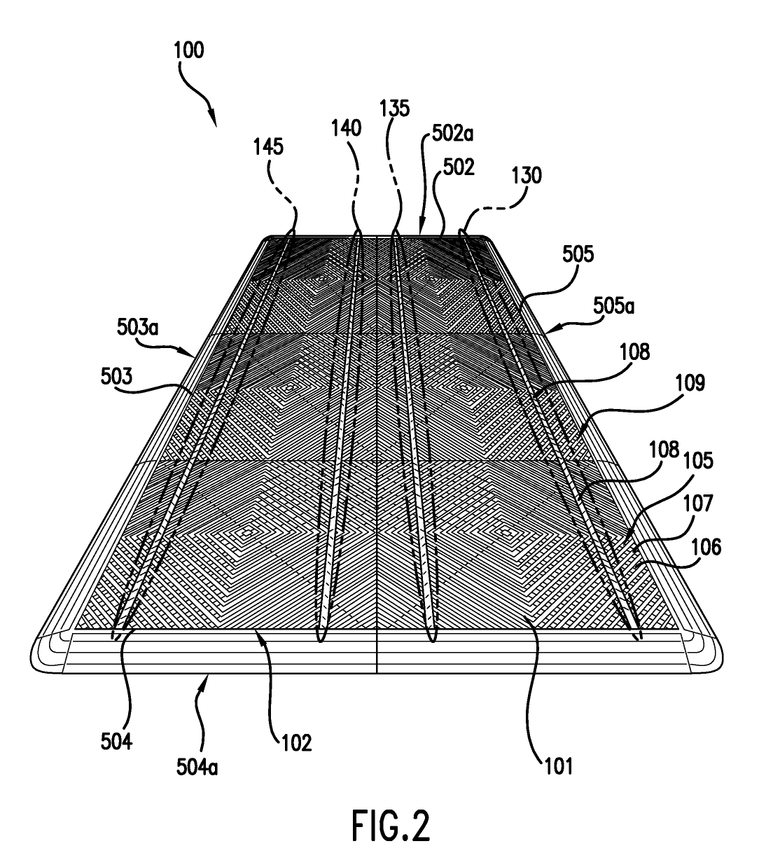

A first channel 130 and an LED strip 120 have been described. The features and functions of the first channel are the same as the second channel 135, third channel 140 and fourth channel 145 as shown in FIG. 2. FIG. 2 is a perspective view of the lighted flooring without the light strips. A second light strip 136, third light strip 137 and fourth light strip 138 are supported by the second 135, third 140 and fourth channels 145, respectively. The light strips features are the same as the first light strip 120. Depending on the design desired, the flexibility of the light strips 120 afford bending the lights in a desired shape or design of the supporting channel.

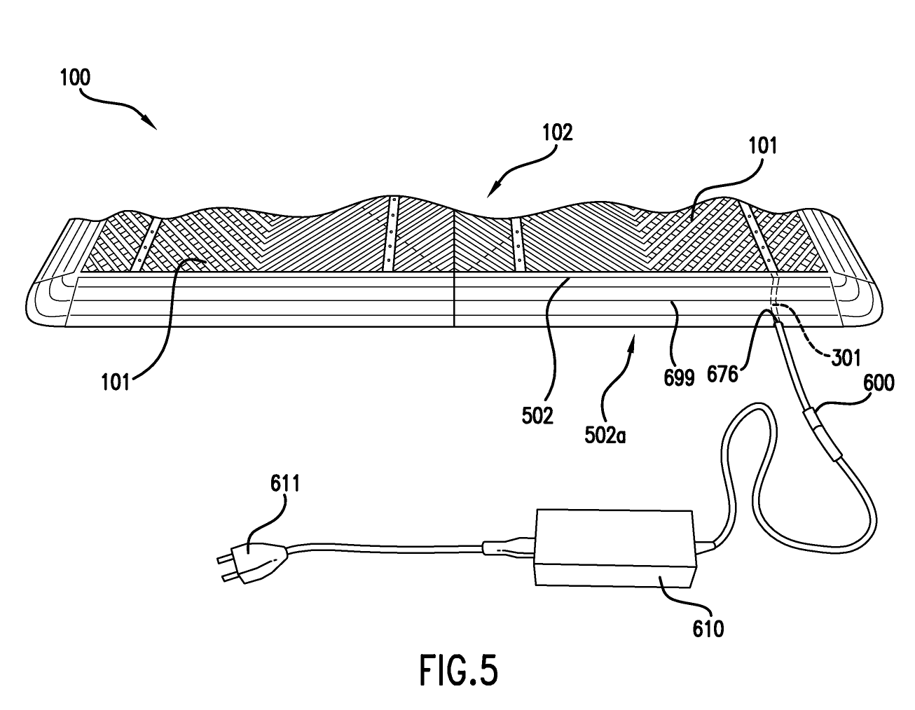

FIG. 3 is a back view of the lighted flooring 100 illustrating a light strip connection 300 and an outer edge 400a. The light strips 120, 136, 137 and 138 have light strip wiring 301 connected to each other along a single path so that the same current flows through all of the strips. The light strips 120, 136, 137 and 138 extend through the channels 130, 135, 140, 145 to the panel edges 502, 504. Wiring 301 extends beyond the panel edges 502 and 504 and are connected to each other. The wiring would extend beyond panel edges 503 and 505 if the channels were cut to extend between edges 503 and 505. Wires 301 from the first strip 120 are connected to the wires 301 of the second strip 136. Wires 301 from the second strip 136 are connected to the wires 301 of the third strip 137. Wires 301 from the third strip 137 are connected to the wires of the fourth strip 138. The remaining wire 301a is connected to an adapter 600 that attaches to a converter 610 having a plug 611 on its end which can be plugged into a standard 110 wall outlet as shown in FIG. 5. FIG. 5 is a front view of the lighted flooring illustrating a cord extending out of the panel and an outer edge 502a. The converter 610 reduces the power of the LED strips 120, 136, 137, and 138. To contain and conceal the wiring 301, outer edges 502a, 503a, 504a and 505a, receive the wiring 301 on the edges bottom side 700 shown in FIG. 3.

The outer edges 502a, 503a, 504a and 505a are made from the same durable material as the tiles so that they can also support large weight objects. The edges 502a-505a form a slight angle on its front outer edge side 699 and act as a ramp. The ramp makes an easier transition for rolling tools on the mat or driving onto the ramp. The outer edges are fitted onto the panel edges. Brackets 900 are evenly spaced on the bottom side 700 of the edges 502a-505a. The brackets 900 are cuts underneath the edges 502a-505a that have a first and second bracket side wall 901, 902. The area between the side walls 901 and 902 are such that the wiring 301 fits snuggly between the walls 901 and 902 and are held firmly in position. Electrical tape may be used around the wires to prevent them from disconnecting.

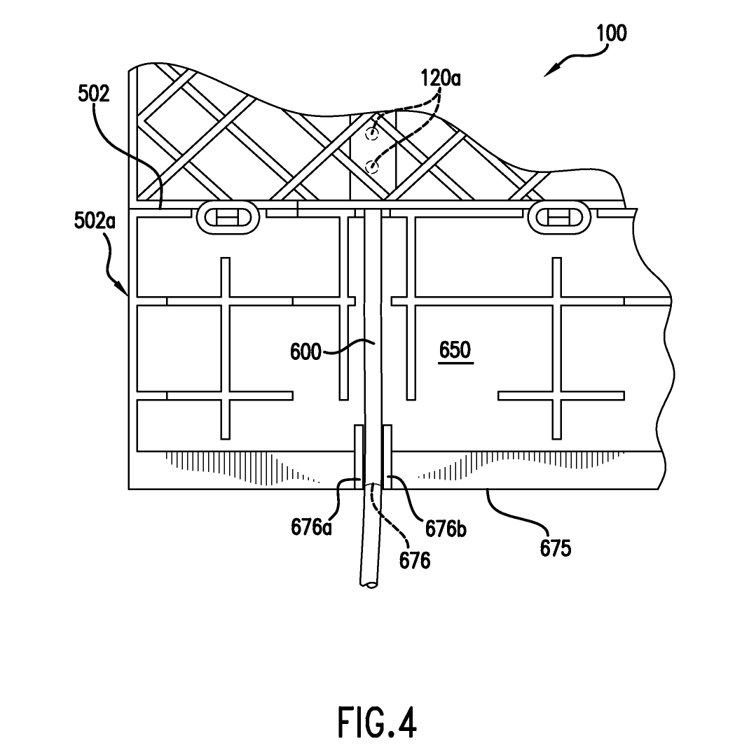

FIG. 4 is a back view of the lighted flooring illustrating a cord extending out of the panel 102 and an outer edge 502a. Wire 301 is connected to an adaptor 600 that makes direct contact with the back outer edge 650 of the outer edge 502a. The outermost perimeter 675 has an opening 676 that is cut a height such that the bottom of the adaptor cord is level with the bottom of the outermost perimeter 675. The walls 676a, 676b of the perimeter 675 prevent the cord from moving out of its desired position.

Clips can be used on a bottom side of the panel to further hold the LED strips in place and the clips may be used on the outer edges to hold the wiring in position.

A power cord is shown, however, other known power source methods such as batteries or solar power may be used to power the light strips. A switch may be added. Also, dimmers may be added to the flooring to allow the brightness of the light strips to be altered. Additionally, timers may be added to the flooring to provide when the strips will be powered on and off.

The flooring acts as a spotlight underneath vehicles and provides an efficient and inexpensive method of lighting dim or dark areas such as front porches or other areas. The materials are lightweight so that the flooring can be transported. The invention has been described in detail with particular reference to certain preferred embodiments thereof, but it will be understood that variations and modifications can be effected within the spirit and scope of the invention.

1. A flooring comprising:
tiles connected together to form a panel, wherein the tiles have a front portion and a back portion;
front ribs on the front portion of the tiles;
back ribs on the back portion of the tiles;
a first channel on the front portion of the panel;
a first light strip positioned in the first channel, wherein the first light strip is flush with a surface of the front ribs.

2. The flooring of claim 1 further comprising outer edges having a front outer edge side and a back outer edge side, wherein the back outer edge side comprises brackets that receive a first light strip wiring.

3. The flooring of claim 1, wherein the first light strip further comprises a waterproof sheath surrounding the strip.

4. The flooring of claim 1, wherein the front and back ribs are positioned to form apertures between them.

5. The flooring of claim 2, wherein the first light strip wiring is connected to a power converter having a corded plug.

6. The flooring of claim 2. wherein the outer edges are angled and act as a ramp.

7. The flooring of claim 1 further comprising a second channel on the front portion of the panel, wherein a second light strip is positioned in the second channel; whereby the first and second light strip may be connected.

8. A flooring comprising:
a panel, wherein the panel has a front portion and a back portion;
recessed channels extending along the front portion of the panel;
light strips in the channels supported by the back portion of the panel, wherein the light strips have a covering that extends along the length of the light strips;
wherein a top surface of the covering and a top surface of the panels are on the same plane.

9. The flooring of claim 8, wherein the panel comprises panel edges, wherein the panel edges are connected to outer edges that receive a light strip wiring.

10. The flooring of claim 8, further comprising clips to further support the light strip.

11. The flooring of claim 8, wherein the light strips comprise wiring that connects the light strips along the outer edges.

12. A portable flooring comprising:
a panel having a front surface and a back surface;
a first, second, third and fourth channel extending along the front surface of the panel;
a first light strip, second light strip, third light strip and fourth light strip supported by the first, second, third and fourth channels, respectively;
wherein the first, second, third and fourth light strips are connected along an edge of the panel;
a covering surrounding the light strips;
wherein a top surface of the covering and a front surface of the panels are flush.

13. The portable flooring of claim 12, wherein the channels are symmetrical on a first and second half of the panel.

14. The portable flooring of claim 12, wherein the light strips are flexible.

15. The portable flooring of claim 12, wherein the light strips are recessed in their respective channels.

16. The portable flooring of claim 12, wherein the flooring can support large weighted objects.
